(19) United States
(12) Patent Application Publication
(10) Pub. No.: US 2025/0390861 A1
(43) Pub. Date: Dec. 25, 2025

(54) METHOD AND SYSTEM FOR NON-FUNGIBLE TOKEN VALIDATION FOR ENABLING PAYMENT ACCOUNT TRANSACTION BLOCKING

(71) Applicant: Mastercard International Incorporated, Purchase, NY (US)

(72) Inventors: Eduardo ABREU, Miami, FL (US); David J. SENCI, Troy, IL (US); Kyle WILLIAMS, Wentzville, MO (US)

(73) Assignee: Mastercard International Incorporated, Purchase, NY (US)

(21) Appl. No.: 18/753,393

(22) Filed: Jun. 25, 2024

(51) Int. Cl. G06Q 20/36; G06Q 20/40

(52) U.S. Cl. CPC G06Q 20/367; G06Q 20/40

(57) ABSTRACT

A method for account and transaction blocking for payment transactions using validation of non-fungible tokens includes: storing a token profile associated with a non-fungible token including a token identifier and transaction criteria; storing an account profile including an account identifier, a payment account number associated with a transaction account, and a wallet identifier associated with a blockchain wallet; receiving an authorization request for a payment transaction including the payment account number and transaction data values; determining that the transaction data values satisfy the transaction criteria; determining if the blockchain wallet has ownership of the non-fungible token; and processing the payment transaction, where processing the payment transaction comprises returning an authorization response indicating decline of the payment transaction if the blockchain wallet does not have ownership of the non-fungible token, or forwarding the authorization request if the blockchain wallet does to have ownership of the non-fungible token.

### FIELD

The present disclosure relates to the validation of non-fungible tokens and the blocking of transactions based thereon, specifically the blocking of specific payment transactions attempted via transaction accounts tied to the validation of non-fungible tokens based on ownership thereof.

### BACKGROUND

Blockchains were first created as a way of providing for a cryptographic unit of value (e.g., currency) that could be transferred among participants in a decentralized manner that provided the participants with pseudonymity. Over time, participants discovered new uses for blockchains in a variety of different industries and applications. A recent new application for blockchains is in conjunction with non-fungible tokens, most commonly referred to as “NFTs.” An NFT is a unique digital object that can be bought and sold, whose provenance is tracked on a blockchain. At its inception, NFTs were most often digital artwork, but they have since expanded to also include other digital objects, such as representing items in online video games, songs, sports video clips, etc. An NFT, once created, is stored in a blockchain with transfers of ownership recorded therein.

More recently, merchants, manufacturers, and other entities have partnered with creators to provide NFTs that are tied with special offers. For example, a credit card issuer can offer a credit card with a printed design of an NFT owned by the cardholder, a merchant can offer a discount to purchases made by owners of a specific NFT, and a manufacturer can offer an exclusive good for purchase only by owners of a specific NFT. However, due to the wide variety of blockchains that can be used to track ownership of an NFT and the amount of data analysis and computing power necessary to keep apprised of ownership changes, it can be exceedingly difficult for merchants to keep aware of all of the potential effects of NFT ownership on transactions as well as ensuring that such effects are properly implemented. Some entities can provide services to track ownership of specified NFTs on behalf of a merchant, but such services are typically periodic, which can be taken advantage of by more nefarious consumers, and still require significant action by merchants to ensure that discounts or other effects are processed properly. As a result, consumers, merchants, and creators are not able to make the most out of such potential partnership opportunities and offers. Thus, there is a need for a technological solution that can simplify the validation of NFT ownership for use in payment transactions to have greater convenience and heightened effectiveness for both consumers and merchants.

### SUMMARY

The present disclosure provides a description of systems and methods for account and transaction blocking for payment transactions using validation of non-fungible tokens. A processing server can maintain a link between transaction accounts and non-fungible tokens (NFTs) owned by blockchain wallets associated with the transaction accounts. When ownership of an NFT is changed, a listener can provide a notification to the processing server of the change of ownership, which can be used by the processing server to sever a link for a transaction account with an NFT that is no longer owned and create a new link between the NFT and the transaction account associated with the blockchain wallet that is the new owner of the NFT. The processing server can also maintain information regarding transaction criteria for each NFT. When an authorization request for a new transaction is received, the processing server can identify any NFT that is applicable to the transaction, such as when a transaction is for the purchase of a product that can be exclusively purchased by owners of a specific type of NFT. The processing server can then identify if the transaction account that is submitted for use to fund the payment transaction is linked to an applicable NFT. If no linkage exists, the payment transaction can be denied. If a link exists, then the processing server 102 can forward the authorization request for processing using traditional methods. The result is that any type of transaction benefit that can be provided via NFT ownership can be implemented successfully and conveniently without any modification to existing transaction processes, providing significant benefits to consumers, merchants, and others, without having to change traditional practices.

A method for account and transaction blocking for payment transactions using validation of non-fungible tokens includes: storing, in a token database of a processing server, a token profile associated with a non-fungible token, the token profile including at least a token identifier and one or more transaction criteria; storing, in an account database of the processing server, an account profile, the account profile including at least an account identifier, a payment account number associated with a transaction account, and a wallet identifier associated with a blockchain wallet; receiving, by a receiver of the processing server, an authorization request for a payment transaction from a first computing system, the authorization request including at least the payment account number and one or more transaction data values; determining, by a processor of the processing server, that the one or more transaction data values included in the received authorization request satisfy the one or more transaction criteria included in the token profile; determining, by the processor of the processing server, if the blockchain wallet associated with the wallet identifier included in the account profile has ownership of the non-fungible token; and processing, by the processor of the processing server, the payment transaction, where processing the payment transaction comprises returning an authorization response to the first computing system indicating decline of the payment transaction if the blockchain wallet is determined to not have ownership of the non-fungible token, or forwarding the authorization request to a second computing system if the blockchain wallet is determined to have ownership of the non-fungible token.

A system for account and transaction blocking for payment transactions using validation of non-fungible tokens includes: a first computing system; and a processing server, the processing server including a token database storing a token profile associated with a non-fungible token, the token profile including at least a token identifier and one or more transaction criteria, an account database storing an account profile, the account profile including at least an account identifier, a payment account number associated with a transaction account, and a wallet identifier associated with a blockchain wallet, a receiver receiving an authorization request for a payment transaction from a first computing system, the authorization request including at least the payment account number and one or more transaction data values, a processor determining that the one or more transaction data values included in the received authorization request satisfy the one or more transaction criteria included in the token profile, determining if the blockchain wallet associated with the wallet identifier included in the account profile has ownership of the non-fungible token, and processing the payment transaction, where processing the payment transaction comprises returning an authorization response to the first computing system indicating decline of the payment transaction if the blockchain wallet is determined to not have ownership of the non-fungible token, or forwarding the authorization request to a second computing system if the blockchain wallet is determined to have ownership of the non-fungible token.

### BRIEF DESCRIPTION OF THE DRAWING FIGURES

The scope of the present disclosure is best understood from the following detailed description of exemplary embodiments when read in conjunction with the accompanying drawings. Included in the drawings are the following figures:

FIG. 1 is a block diagram illustrating a high level system architecture for account and transaction blocking for payment transactions using validation of non-fungible tokens in accordance with exemplary embodiments.

FIG. 2 is a block diagram illustrating the processing server in the system of FIG. 1 for account and transaction blocking for payment transactions using validation of non-fungible tokens in accordance with exemplary embodiments.

FIGS. 3A and 3B are a flow diagram illustrating a process for account and transaction blocking for payment transactions using validation of non-fungible tokens in the system of FIG. 1 in accordance with exemplary embodiments.

FIG. 4 is a flow chart illustrating an exemplary method for account and transaction blocking for payment transactions using validation of non-fungible tokens in accordance with exemplary embodiments.

FIG. 5 is a block diagram illustrating a computer system architecture in accordance with exemplary embodiments.

Further areas of applicability of the present disclosure will become apparent from the detailed description provided hereinafter. It should be understood that the detailed description of exemplary embodiments is intended for illustration purposes only and are, therefore, not intended to necessarily limit the scope of the disclosure.

### DETAILED DESCRIPTION

### System for Payment Transaction Processing Based on Validation of Non-Fungible Tokens

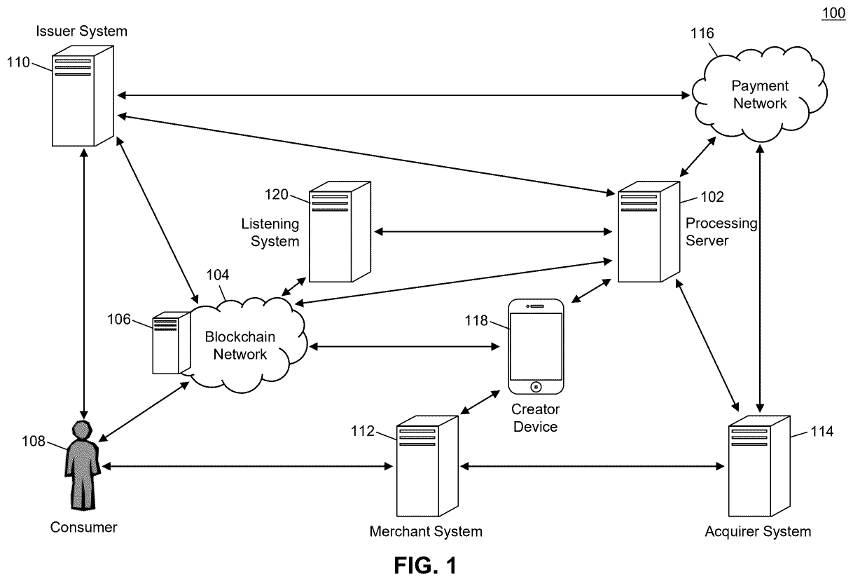

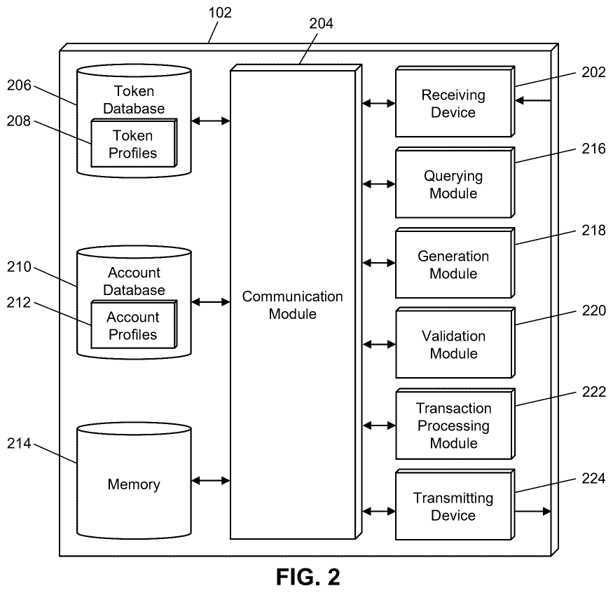

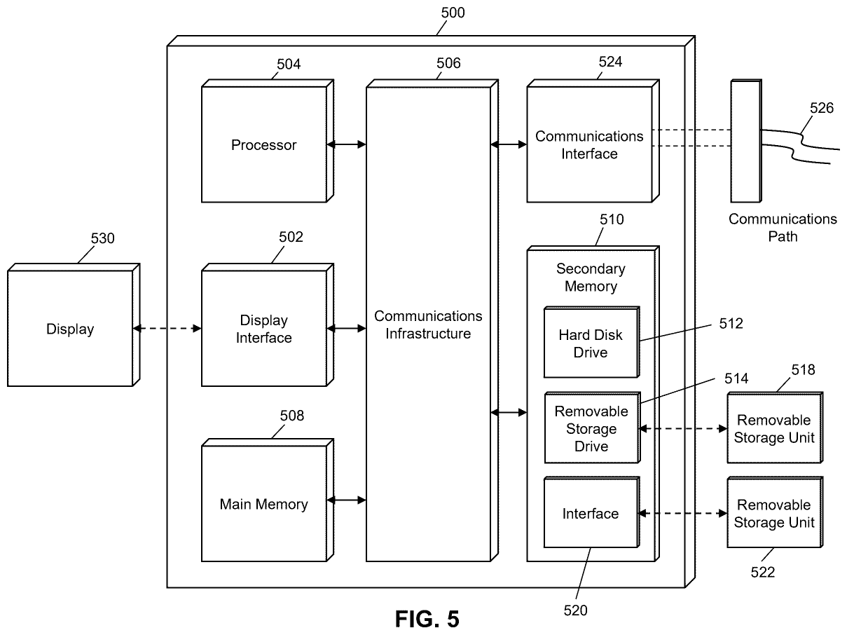

FIG. 1 illustrates a system 100 for the account and transaction blocking for payment transactions using validation of non-fungible tokens (NFTs). The system 100 can include a processing server 102. The processing server 102, discussed in more detail below, can be a computing system, such as illustrated in FIG. 2 or 5, discussed in more detail below, that is configured to validate the applicability of an NFT to a payment transaction and block payment transactions and/or transaction accounts based on ownership of applicable NFTs. The system 100 can also connect to at least one blockchain network 104. The blockchain network 104 can be comprised of a plurality of blockchain nodes 106. Each blockchain node 106 can be a computing system, such as illustrated in FIG. 5, discussed in more detail below, that is configured to perform functions related to the processing and management of the blockchain, including the generation of blockchain data values, verification of proposed blockchain transactions, verification of digital signatures, generation of new blocks, validation of new blocks, and maintenance of a copy of the blockchain.

The blockchain can be a distributed ledger that is comprised of at least a plurality of blocks. Each block can include at least a block header and one or more data values. Each block header can include at least a timestamp, a block reference value, and a data reference value. The timestamp can be a time at which the block header was generated and can be represented using any suitable method (e.g., UNIX timestamp, DateTime, etc.). The block reference value can be a value that references an earlier block (e.g., based on timestamp) in the blockchain. In some embodiments, a block reference value in a block header can be a reference to the block header of the most recently added block prior to the respective block. In an exemplary embodiment, the block reference value can be a hash value generated via the hashing of the block header of the most recently added block. The data reference value can similarly be a reference to the one or more data values stored in the block that includes the block header. In an exemplary embodiment, the data reference value can be a hash value generated via the hashing of the one or more data values. For instance, the block reference value can be the root of a Merkle tree generated using the one or more data values.

The use of the block reference value and data reference value in each block header can result in the blockchain being immutable. Any attempted modification to a data value would require the generation of a new data reference value for that block, which would thereby require the subsequent block's block reference value to be newly generated, further requiring the generation of a new block reference value in every subsequent block. This would have to be performed and updated in every single blockchain node 106 in a blockchain network 104 prior to the generation and addition of a new block to the blockchain in order for the change to be made permanent. Depending on the blockchain, computational and communication limitations may make such a modification exceedingly difficult, if not impossible, thus rendering the blockchain immutable.

In some embodiments, the blockchain can be used to store information regarding blockchain transactions conducted between two different blockchain wallets. A blockchain wallet can include a private key of a cryptographic key pair that is used to generate digital signatures that serve as authorization by a payer for a blockchain transaction, where the digital signature can be verified by the respective blockchain network 104 using the public key of the cryptographic key pair. In some cases, the term “blockchain wallet” can refer specifically to the private key. In other cases, the term “blockchain wallet” can refer to a computing device (e.g., of a consumer 108) that stores the private key for use thereof in blockchain transactions. For instance, each computing device can have their own private key for respective cryptographic key pairs and can each be a blockchain wallet for use in transactions with the blockchain associated with the blockchain network. Computing devices can be any type of device suitable to store and utilize a blockchain wallet, such as a desktop computer, laptop computer, notebook computer, tablet computer, cellular phone, smart phone, smart watch, smart television, wearable computing device, implantable computing device, etc.

Each blockchain data value stored in the blockchain can correspond to a blockchain transaction or other storage of data, as applicable. A blockchain transaction can consist of at least: a digital signature of the sender of a unit of value (e.g., currency) that is generated using the sender's private key, a blockchain address of the recipient of the unit of value (e.g., currency) generated using the recipient's public key, and a blockchain currency amount that is transferred or other data being stored. In some blockchain transactions, the transaction can also include one or more blockchain addresses of the sender where blockchain currency is currently stored (e.g., where the digital signature proves their access to such currency), as well as an address generated using the sender's public key for any change that is to be retained by the sender. Addresses to which cryptographic currency has been sent that can be used in future transactions are referred to as “output” addresses, as each address was previously used to capture output of a prior blockchain transaction, also referred to as “unspent transactions,” due to there being currency sent to the address in a prior transaction where that currency is still unspent. In some cases, a blockchain transaction can also include the sender's public key, for use by an entity in validating the transaction. For the traditional processing of a blockchain transaction, such data can be provided to a blockchain node 106 in a blockchain network 104, either by the sender or the recipient. The node can verify the digital signature using the public key in the cryptographic key pair of the sender's wallet and also verify the sender's access to the funds (e.g., that the unspent transactions have not yet been spent and were sent to address associated with the sender's wallet), a process known as “confirmation” of a transaction, and then include the blockchain transaction in a new block. The new block can be validated by other blockchain nodes 106 in the blockchain network 104 before being added to the blockchain and distributed to all of the blockchain nodes 106 in the blockchain network 104, respectively, in traditional blockchain implementations. In cases where a blockchain data value cannot be related to a blockchain transaction, but instead the storage of other types of data, blockchain data values can still include or otherwise involve the validation of a digital signature.

In the system 100, a creator device 118 (e.g., or a user 108 of the creator device 118, collectively referred to herein as the creator device 118) can create a new NFT. The NFT can be any digital object that can be stored on a blockchain directly or via a reference identifier associated with the digital object (e.g., a hash value generated using the digital object). The creator device 118 can submit the NFT to a system to make available for sale, such as a marketplace, a blockchain node 106, a merchant system 112, etc. The system can be a computing system configured to perform the functions discussed herein, which can include the receipt, storage, and posting of NFTs for sale and the tracking of ownership transfers thereof. In some cases, the system can be a blockchain node 106 in a blockchain network 104 that stores data related to NFTs. In other cases, the system can be in communication with one or more blockchain nodes 106 in a blockchain network 104 that operates a blockchain for the storage of NFT data.

The system 100 can also include components related to the processing of payment transactions for the purchase of goods or services via transaction accounts. The system 100 can include a consumer 108. As discussed herein, consumer 108 can refer to an individual or entity to which a transaction account is issued for use in funding payment transactions and can also refer to any computing device or other system associated with or used by the individual or entity to perform functions as discussed herein. For instance, consumer 108 can refer to a user that participates in the blockchain associated with the blockchain network 104 that is used for NFT ownership as well as to the computing device used by the consumer 108 that controls a blockchain wallet used to claim and transfer ownership of an NFT.

In the system 100, the consumer 108 can be issued a transaction account for use in funding payment transactions by an issuer system 110. A transaction account can be a financial account that may be used to fund a transaction, such as a checking account, savings account, credit account, virtual payment account, etc. A transaction account may be associated with a consumer, which may be any suitable type of entity associated with a payment account, which may include a person, family, company, corporation, governmental entity, etc. In some instances, a transaction account may be virtual, such as those accounts operated by PayPal®, etc. The issuer system 110 can refer to an issuer and/or any computing system utilized by or on behalf of the issuer that is used to perform functions for the issuer as discussed herein. An issuer can be any entity that establishes (e.g., opens) a letter or line of credit in favor of a beneficiary, and honors drafts drawn by the beneficiary against the amount specified in the letter or line of credit. In many instances, the issuer may be a bank or other financial institution authorized to open lines of credit. In some instances, any entity that may extend a line of credit to a beneficiary may be considered an issuer. The line of credit opened by the issuer may be represented in the form of a payment account and may be drawn on by the beneficiary via the use of a payment card. An issuer may also offer additional types of payment accounts to consumers as will be apparent to persons having skill in the relevant art, such as debit accounts, prepaid accounts, electronic wallet accounts, savings accounts, checking accounts, etc., and may provide consumers with physical or non-physical means for accessing and/or utilizing such an account, such as debit cards, prepaid cards, automated teller machine cards, electronic wallets, checks, etc.

The consumer 108 can be issued payment details for the transaction account to be presented during the initiation of a payment transaction to indicate that the associated transaction account is to be used to fund the payment transaction. The payment details can include a payment account number and any other additional data used in the authentication and verification of the transaction account, such as a name, zip code, billing address, expiration date, security code, etc. In some cases, the consumer 108 can be issued a physical payment card that displays and/or is encoded with the payment details. In other instances, the consumer 108 can be provided with the payment details electronically, such as via e-mail, an application program, a web page accessible via authentication of the consumer 108, etc.

In the system 100, the consumer 108 can initiate a payment transaction with a merchant for the purchase of one or more goods or services, collectively referred to herein as “products,” via payment that is funded using the issued transaction account. As discussed herein, merchant system 112 can refer to the merchant as well as any computing device or system used by or on behalf of the merchant in the performance of functions discussed herein. The merchant system 112 can be associated with any entity that provides products in exchange for currency through payment transactions. The merchant system 112 can be issued a transaction account by an acquirer system 114 that can be used to receive payment as a result of successfully processed payment transactions. As used herein, the acquirer system 114 can refer to an acquirer and/or any computing devices or systems used by or on behalf of the acquirer for performing the functions of the acquirer system 114 discussed herein. An acquirer can be any entity that may process payment card transactions on behalf of a merchant. The acquirer may be a bank or other financial institution authorized to process payment card transactions on a merchant's behalf. In many instances, the acquirer may open a line of credit with the merchant acting as a beneficiary. The acquirer may exchange funds with an issuer in instances where a consumer, which may be a beneficiary to a line of credit offered by the issuer, transacts via a payment card with a merchant that is represented by the acquirer.

In a traditional payment transaction, the consumer 108 can initiate the payment transaction with the merchant system 112 by selecting products for purchase and providing payment details for their transaction account to the merchant system 112, such as via a web page, an application program, or at a point of sale at a physical location of the merchant system 112. The merchant system 112 can receive the payment details and submit the payment details as well as additional transaction data values for the payment transaction to the acquirer system 114 using any suitable communication network and method. Additional transaction data values can include any additional data associated with the transaction used in the processing of the payment transaction as well as any functions discussed herein. Transaction data values can include, for example, transaction amount, transaction time, transaction data, merchant identifier, bank identification number, point of sale identifier, currency type, exchange rate, payment method, product data, reward data, offer data, coupon data, etc. The acquirer system 114 can receive the transaction data from the merchant system 112, which can include the payment details and the additional transaction data values and submit an authorization request to a payment network 116 for processing.

The payment network 116 can be a system or network used for the transfer of money via the use of cash-substitutes for thousands, millions, and even billions of transactions during a given period. Payment networks may use a variety of different protocols and procedures in order to process the transfer of money for various types of transactions. Transactions that may be performed via a payment network may include product or service purchases, credit purchases, debit transactions, fund transfers, account withdrawals, etc. Payment networks may be configured to perform transactions via cash-substitutes, which may include payment cards, letters of credit, checks, transaction accounts, etc. Examples of networks or systems configured to perform as payment networks include those operated by Mastercard®, VISA®, Discover®, American Express®, PayPal®, etc. Use of the term “payment network” herein may refer to both the payment network as an entity, and the physical payment network, such as the equipment, hardware, and software comprising the payment network. As used herein, “payment rails” can refer to the network infrastructure used to transmit transaction messages to and from the payment network 116.

The payment network 116 can receive the authorization request from the acquirer system 114 and process the authorization request using traditional methods. An authorization request can be a specific type of transaction message that indicates a payment transaction needs to be authorized by the issuer system 110 that issued the transaction account as well as any other applicable entity, such as to ensure compliance of the payment transaction with any applicable rules or regulations and to ensure that the transaction account selected for use in funding the payment transaction by the consumer 108 has sufficient funding and/or credit to cover the transaction amount for the payment transaction. A transaction message can be a specially formatted data message that is formatted pursuant to one or more standards governing the exchange of financial transaction messages, such as the International Organization of Standardization's ISO 8583 or ISO 20022 standards. A transaction message can include a plurality of data elements, where each element can store transaction data values as indicated in the applicable standard, as well as other data as indicated in the applicable standard. An authorization request can be indicated via a message type indicator of the transaction message that indicates that the transaction message is an authorization request.

In a traditional payment transaction, the payment network 116 can perform any added services as part of the processing of the payment transaction for which the authorization request is received, such as fraud scoring, and forward the authorization request to the issuer system 110, which can be identified via the payment account number (e.g., via a bank identification number or other value included therein) or other data included in the additional transaction data values included in the received authorization request. The issuer system 110 can receive the authorization request and determine whether or not to approve the payment transaction, such as based on the available funding and/or credit of the transaction account associated with the payment account number to cover the transaction amount for the payment transaction, as well as compliance with any applicable controls. The issuer system 110 can provide an authorization response back to the payment network 116 using the payment rails that includes a data element that includes a response code indicating approval or decline of the payment transaction. The authorization response can include a message type indicator indicative of an authorization response. In some cases, the authorization response can be a modified authorization request. In other cases, the authorization response can be a newly generated transaction message.

The payment network 116 can receive the authorization response from the issuer system 110 and forward the authorization response to the acquirer system 114 using the payment rails of the payment network 116. The acquirer system 114 can provide the authorization response or at least an indication of approval or decline of the payment transaction based thereon to the merchant system 112. The merchant system 112 can then finalize the payment transaction, such as by informing the consumer 108 of a decline by the issuer system 110 and preventing purchase of the selected products or by providing the consumer 108 with the selected products as well as a receipt or other information regarding the approved payment transaction.

In the system 100, ownership of an NFT can be used by a consumer 108 to participate in payment transactions that can be unavailable to any consumer 108 that does not own an authorized NFT. In examples, NFT ownership can be used to authorize a consumer 108 to purchase an exclusive product not available to consumers 108 that do not own an authorized NFT, to receive a discount at a merchant system 112, to be issued a specific transaction account, to be allowed to transact with a specific merchant system 112, etc. Such effects can be provided to the processing server 102 by the creator device 118, merchant system 112, issuer system 110, or other suitable entity. The processing server 102 can receive the information as well as other data for an NFT and create a token profile for storage in a token database that is associated with the NFT.

The token profile for an NFT can include at least a token identifier and one or more transaction criteria. The token identifier can be a unique value that is uniquely associated with the related NFT among all other NFTs used in the system 100. In some cases, the token identifier can be the same unique identifier used by the NFT in the blockchain for which ownership of the NFT is stored. In other cases, the token identifier can be a different unique value. In such cases, the token profile can also include the unique identifier used by the NFT in the blockchain. In some cases, the token profile can also include a contract identifier or any other information related to the NFT. The one or more transaction criteria can be the effects of the related NFT on payment transactions. In an example where NFT ownership allows a consumer 108 to purchase an exclusive product, the one or more transaction criteria can include a product identifier for the exclusive product or a merchant identifier associated with purchase of the exclusive product (e.g., where a merchant system 112 can have a standard merchant identifier for regular payment transactions and a separate merchant identifier used in payment transactions for the purchase of the exclusive product). In an example where a transaction account can only be used while ownership of an NFT is maintained, the one or more transaction criteria can include the bank identification number associated with the exclusive transaction accounts.

When an authorization request is submitted for a payment transaction, the authorization request can be provided to the processing server 102 (e.g., directly from the acquirer system 114 for processed by the processing server 102 prior to submission to the payment network 116, or by the payment network 116 prior to forwarding of the authorization request to the issuer system 110). In some embodiments, the processing server 102 can be a part of the payment network 116 and receive the authorization request via internal transmission of the payment network 116. In other cases, the processing server 102 can receive the authorization request via payment rails of the payment network 116. The processing server 102 can determine if any NFTs registered with the processing server 102 (e.g., for which a token profile exists) are applicable to the payment transaction, such as based on the one or more transaction criteria included in the token profiles as compared to the transaction data values stored in the authorization request. In the above first example, product data included in the transaction data values that includes a product identifier stored in a token profile indicates applicability of the NFT associated with the token profile. In the above second example, the bank identification number included in the transaction data values being included in a token profile indicates applicability of the associated NFT.

If the processing server 102 determines that no NFT ownership is applicable to the payment transaction, then the processing server 102 can forward the authorization request to the payment network 116 or directly to the issuer system 110, as applicable. If the processing server 102 determines that NFT ownership is applicable to the payment transaction, then the processing server 102 can then identify if the transaction account being used in the payment transaction has ownership of the NFT. The processing server 102 can track ownership of NFTs by transaction accounts through the use of linkages between token profiles and account profiles.

The processing server 102 can store account profiles in an account database, where each account profile can be associated with a transaction account tied to a blockchain wallet that can be used to claim ownership of an NFT on the blockchain in the system 100. In some cases, transaction accounts can be registered with the processing server 102 prior to ownership of an NFT, such as through an onboarding process performed by the issuer system 110 or consumer 108. In other cases, transaction accounts can be registered when ownership of an NFT for which a token profile is stored on the processing server 102 is claimed by a blockchain wallet associated with a transaction account. An account profile can include a payment account number for the transaction account as well as a wallet identifier for the blockchain wallet. The wallet identifier can be the public key of the cryptographic key pair that serves as the blockchain wallet or any other suitable identification value. In some cases, blockchain wallet ownership or control can be verified prior to the generation of an account profile, such as through the validation of a digital signature generated by a private key of the cryptographic key par that serves as the blockchain wallet. In some instances, ownership or control of the transaction account can also be verified, such as through traditional authentication processes.

When ownership of an NFT changes on the blockchain, the processing server 102 can sever or create links between token profiles and account profiles accordingly. If ownership of an NFT is being claimed for the first time, a new link can be created between the token profile for the NFT and the account profile that includes the wallet identifier for the blockchain wallet to which ownership was transferred on the blockchain. If ownership is being transferred from one blockchain wallet to another, the processing server 102 can sever and/or remove a link between the token profile for the NFT and the account profile that includes the wallet identifier for the blockchain wallet from which ownership of the NFT is being transferred and create a link between the token profile for the NFT and the account profile that includes the wallet identifier for the blockchain wallet to which ownership of the NFT is being transferred. Links between token profiles and transaction accounts can be stored by the processing server 102 using any suitable method. For instance, the wallet identifier from the account profile can be stored in the token profile, the token identifier for the NFT can be stored in the account profile, a data entry in a link database can be created that includes the token identifier and the wallet identifier, etc.

In some embodiments, the processing server 102 can monitor for ownership changes on the blockchain and remove and create links accordingly. In other embodiments, the system 100 can include a listener system 120. The listener system 120 can be a computing system that monitors the blockchain for changes in ownership of an NFT. In some cases, the listener system 120 can monitor for changes in ownership of all NFTs and provide notifications of such changes to the processing server 102. In some instances, the listener system 120 can monitor only for changes in ownership for NFTs for which the processing server 102 has created token profiles (e.g., using token identifiers for the token profiles provided by the processing server 102). In other instances, the listener system 120 can monitor for changes of ownership of all NFTs on the blockchain, but only report changes in ownership to the processing server 102 for those NFTs for which the processing server 102 has created token profiles, such as by identifying such NFTs via a list of token identifiers provided by the processing server 102. To notify the processing server 102 of the change in ownership of an NFT, the listening system 120 can generate an ownership transfer notification, which can include at least the token identifier for the NFT and the wallet identifier for the new blockchain wallet that has received ownership of the NFT. In some cases, the ownership transfer notification can also include the wallet identifier for the blockchain wallet that transferred ownership of the NFT to the new blockchain wallet. The processing server 102 can receive an ownership transfer notification from the listening system 120 and then modify links between token profiles and account profiles accordingly, as discussed above. In some embodiments, a blockchain wallet can self-report a transfer of ownership of an NFT through submission of an ownership transfer notification to the processing server 102. In some such embodiments, the processing server 102 can verify the transfer by identifying the transfer on the blockchain using the data provided in the ownership transfer notification.

When processing an authorization request for a payment transaction, once the processing server has identified that NFT ownership is applicable to the payment transaction, the processing server 102 can determine if there is a link between the token profile for the applicable NFT and the account profile associated with the transaction account selected for use in funding the payment transaction. If no such link exists, the processing server 102 can return an authorization response indicating that the payment transaction is declined. In some cases, the response code included in the authorization response can indicate that the transaction is not authorized due to non-ownership of an applicable NFT. If a link exists, then the processing server 102 can forward the authorization request to the issuer system 110 (e.g., directly or via the payment network 116) for further processing using traditional methods and systems.

In some embodiments, the processing server 102 can be configured to enforce additional criteria for the applicability of an NFT to a payment transaction. For instance, NFT ownership can be subject to additional constraints that are not included in traditional transaction data values. For example, a manufacturer can specify that an NFT must be owned for at least 24 hours before it can be used to purchase an exclusive product. In another example, a merchant system 112 can allow transactions only for NFT owners but limit such transactions to one for each owner of an NFT, or to a single transaction for the NFT regardless of ownership. In such examples, a token profile can include additional data regarding NFT ownership applicability, where additional data regarding the tracking thereof can also be stored in the token profile and/or account profiles, as applicable. For instance, in the first example above, the token profile for the NFT can include the 24 hour requirement, and the link between the token profile and any account profile can include a timestamp, which can be used to evaluate for compliance with the 24 hour requirement when a payment transaction is attempted. In the second example above, a token profile can include a payment account number for any transaction account that has already been used in a payment transaction for which ownership of the NFT was required, where inclusion of the payment account number in a new authorization request to which ownership of the NFT is applicable can result in a decline of the payment transaction.

The methods and systems discussed herein provide for the blocking of payment transactions and transaction accounts based on the validation of ownership of NFTs. By performing the validation and blocking at a processing server 102, consumers 108 and merchant systems 112 can take advantage of NFT ownership benefits without changing the traditional transaction process, providing for ease of use and adoption while encouraging consumers to transact and driving additional traffic to merchants. The use of transaction criteria and blocking of a transaction during traditional processing can ensure that a wide variety of possible benefits for NFT ownership can be successfully implemented without difficulty for issuer systems 110, merchant systems 112, and other entities and without modification to standard transaction processing for the involved entities. The result is a significant improvement for the participants over traditional systems.

### Processing Server

FIG. 2 illustrates an embodiment of a processing server 102 in the system 100 of FIG. 1. It will be apparent to persons having skill in the relevant art that the embodiment of the processing server 102 illustrated in FIG. 2 is provided as illustration only and cannot be exhaustive to all possible configurations of the processing server 102 suitable for performing the functions as discussed herein. For example, the computer system 500 illustrated in FIG. 5 and discussed in more detail below can be a suitable configuration of the processing server 102.

The processing server 102 can include a receiving device 202. The receiving device 202 can be configured to receive data over one or more networks via one or more network protocols. In some instances, the receiving device 202 can be configured to receive data from blockchain nodes 106, issuer systems 110, merchant systems 112, acquirer systems 114, payment networks 116, creator devices 118, listening systems 120, and other systems and entities via one or more communication methods, such as radio frequency, local area networks, wireless area networks, cellular communication networks, Bluetooth, the Internet, etc. In some embodiments, the receiving device 202 can be comprised of multiple devices, such as different receiving devices for receiving data over different networks, such as a first receiving device for receiving data over a local area network and a second receiving device for receiving data via the Internet. The receiving device 202 can receive electronically transmitted data signals, where data can be superimposed or otherwise encoded on the data signal and decoded, parsed, read, or otherwise obtained via receipt of the data signal by the receiving device 202. In some instances, the receiving device 202 can include a parsing module for parsing the received data signal to obtain the data superimposed thereon. For example, the receiving device 202 can include a parser program configured to receive and transform the received data signal into usable input for the functions performed by the processing device to carry out the methods and systems described herein.

The receiving device 202 can be configured to receive data signals electronically transmitted by blockchain nodes 106 that can be superimposed or otherwise encoded with blockchain data, which can include blockchain transactions for the transfer of ownership of an NFT, which can include a token identifier for the NFT and a wallet identifier for the blockchain wallet to which ownership of the NFT was transferred. The receiving device 202 can also be configured to receive data signals electronically transmitted by issuer systems 110, merchant systems 112, acquirer systems 114, and payment networks 116, which can be superimposed or otherwise encoded with transaction messages, such as authorization requests or authorization responses for payment transactions. The receiving device 202 can also be configured to receive data signals electronically transmitted by creator devices 118, issuer systems 110, or merchant systems 112 that can be superimposed or otherwise encoded with NFT data, which can include a token identifier associated with the NFT and information regarding the applicability and/or benefits of ownership of the NFT for payment transactions. The receiving device 202 can also be configured to receive data signals electronically transmitted by listening systems 120 and consumers 108, which can be superimposed or otherwise encoded with ownership transfer notifications.

The processing server 102 can also include a communication module 204. The communication module 204 can be configured to transmit data between modules, engines, databases, memories, and other components of the processing server 102 for use in performing the functions discussed herein. The communication module 204 can be comprised of one or more communication types and utilize various communication methods for communications within a computing device. For example, the communication module 204 can be comprised of a bus, contact pin connectors, wires, etc. In some embodiments, the communication module 204 can also be configured to communicate between internal components of the processing server 102 and external components of the processing server 102, such as externally connected databases, display devices, input devices, etc. The processing server 102 can also include a processing device. The processing device can be configured to perform the functions of the processing server 102 discussed herein as will be apparent to persons having skill in the relevant art. In some embodiments, the processing device can include and/or be comprised of a plurality of engines and/or modules specially configured to perform one or more functions of the processing device, such as a querying module 216, generation module 218, validation module 220, encryption module 222, etc. As used herein, the term “module” can be software or hardware particularly programmed to receive an input, perform one or more processes using the input, and provides an output. The input, output, and processes performed by various modules will be apparent to one skilled in the art based upon the present disclosure.

The processing server 102 can also include a token database 206. The token database 206 can be configured to store one or more token profiles 208 using a suitable data storage format and schema. The token database 206 can be a relational database that utilizes structured query language for the storage, identification, modifying, updating, accessing, etc. of structured data sets stored therein. Each token profile 208 can be a structured data set configured to store data related to an NFT, which can include, for example, a token identifier uniquely associated with the related NFT and one or more transaction criteria. In some cases, a token profile 208 can also include a link to a payment account number or transaction account, one or more additional criteria, or other data as indicated herein.

The processing server 102 can also include an account database 210. The account database 210 can be configured to store one or more account profiles 212 using a suitable data storage format and schema. The account database 210 can be a relational database that utilizes structured query language for the storage, identification, modifying, updating, accessing, etc. of structured data sets stored therein. Each account profile 212 can be a structured data set configured to store data related to a transaction account, which can include, for example, a payment account number, other account identification data, and a wallet identifier associated with a blockchain wallet.

The processing server 102 can also include a memory 214. The memory 214 can be configured to store data for use by the processing server 102 in performing the functions discussed herein, such as public and private keys, symmetric keys, etc. The memory 214 can be configured to store data using suitable data formatting methods and schema and can be any suitable type of memory, such as read-only memory, random access memory, etc. The memory 214 can include, for example, encryption keys and algorithms, communication protocols and standards, data formatting standards and protocols, program code for modules and application programs of the processing device, and other data that can be suitable for use by the processing server 102 in the performance of the functions disclosed herein as will be apparent to persons having skill in the relevant art. In some embodiments, the memory 214 can be comprised of or can otherwise include a relational database that utilizes structured query language for the storage, identification, modifying, updating, accessing, etc. of structured data sets stored therein.

The processing server 102 can include a querying module 216. The querying module 216 can be configured to execute queries on databases to identify information. The querying module 216 can receive one or more data values or query strings and can execute a query string based thereon on an indicated database, such as the token database 206 of the processing server 102 to identify information stored therein. The querying module 216 can then output the identified information to an appropriate engine or module of the processing server 102 as necessary or appropriate. The querying module 216 can, for example, execute a query on the token database 206 to identify any token profiles 208 that include one or more transaction criteria that match or otherwise applicable to transaction data values included in a received authorization request.

The processing server 102 can also include a generation module 218. The generation module 218 can be configured to generate data for use by the processing server 102 in performing the functions discussed herein. The generation module 218 can receive instructions as input, can generate data based on the instructions, and can output the generated data to one or more modules of the processing server 102. For example, the generation module 218 can be configured to generate token profiles 208, account profiles 212, transaction messages, transaction criteria, data requests, etc.

The processing server 102 can also include a validation module 220. The validation module 220 can be configured to perform data validations and verifications for the processing server 102 as part of the functions discussed herein. The validation module 220 can receive instructions as input, can perform data validations or verification as instructed, and can output a result of the data validations or verifications to one or more modules of the processing server 102. In some cases, the input can include the data to be validated or verified and/or data to be used in the validation or verification. In other cases, the validation module 220 can be configured to identify such data, such as in the token database 206 and/or memory 214. The validation module 220 can be configured to, for example, validate digital signatures, authenticate blockchain wallets, authenticate transaction accounts, validate applicability of ownership of an NFT to an attempted payment transaction, validate a link between a token profile for an NFT applicable to an attempted payment transaction and an account profile for a transaction account selected for use in funding the attempted payment transaction.

The processing server 102 can also include a transaction processing module 222. The transaction processing module 222 can be configured to perform functions related to the processing of payment transactions as part of the functions discussed herein. The transaction processing module 222 can receive instructions as input, can perform transaction processing actions as instructed, and can output a result of the actions to one or more modules of the processing server 102. In some cases, the input can include data to be used in the transaction processing, such as transaction criteria. In other cases, the transaction processing module 222 can be configured to identify such data, such as in the token database 206 and account database 210. The transaction processing module 222 can be configured to identify token profiles 208 applicable to an attempted payment transaction, identify account profiles 212 related to an attempted payment transaction, and determine if an authorization request should be forwarded to an issuer system 110 or an authorization response declining a payment transaction should be returned to an acquirer system 112.

The processing server 102 can also include a transmitting device 224. The transmitting device 224 can be configured to transmit data over one or more networks via one or more network protocols. In some instances, the transmitting device 224 can be configured to transmit data to blockchain nodes 106, consumers 108, issuer systems 110, merchant systems 112, acquirer systems 114, payment networks 116, creator devices 118, listening systems 120, and other entities via one or more communication methods, local area networks, wireless area networks, cellular communication, Bluetooth, radio frequency, the Internet, etc. In some embodiments, the transmitting device 224 can be comprised of multiple devices, such as different transmitting devices for transmitting data over different networks, such as a first transmitting device for transmitting data over a local area network and a second transmitting device for transmitting data via the Internet. The transmitting device 224 can electronically transmit data signals that have data superimposed that can be parsed by a receiving computing device. In some instances, the transmitting device 224 can include one or more modules for superimposing, encoding, or otherwise formatting data into data signals suitable for transmission.

The transmitting device 224 can be configured to electronically transmit data signals to blockchain nodes 106 that can be superimposed or otherwise encoded with blockchain data requests. The transmitting device 224 can also be configured to electronically transmit data signals to issuer systems 110, merchant systems 112, acquirer systems 114, and payment networks 116, which can be superimposed or otherwise encoded with transaction messages, such as authorization requests and authorization responses. The transmitting device 224 can also be configured to electronically transmit data signals to listening systems 120 that can be superimposed or otherwise encoded with token identifiers for which ownership transfer notifications are requested.

### Process for Transaction Blocking and Processing Based on NFT Validation

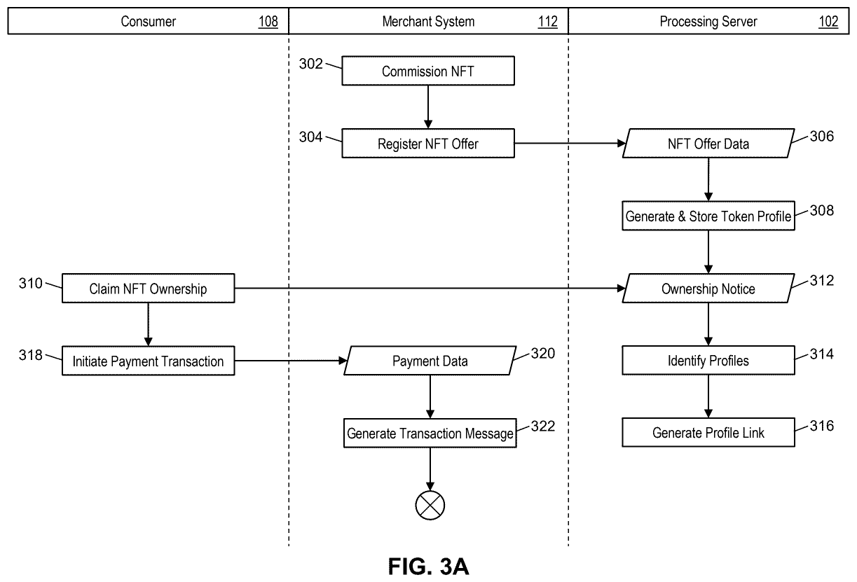

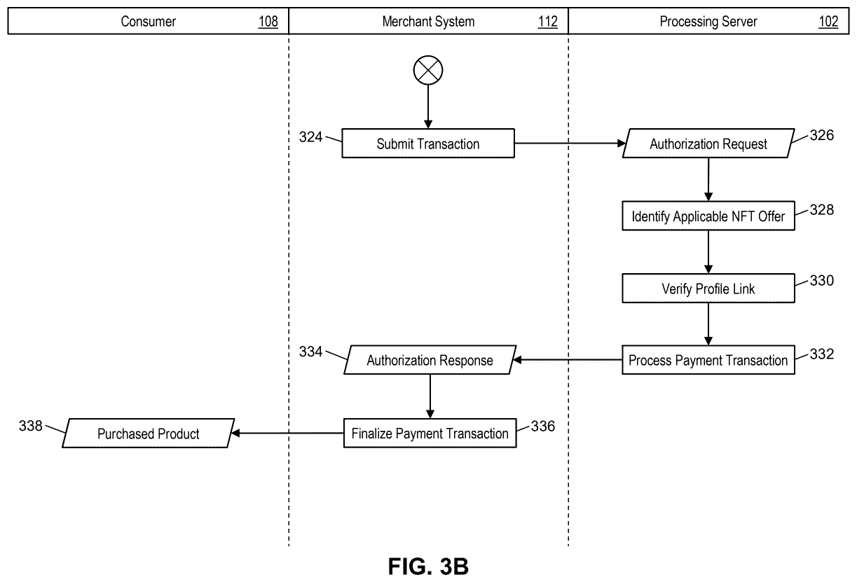

FIGS. 3A and 3B illustrate a process in the system 100 of FIG. 1 for the processing of a payment transaction based on the validation of an NFT applicable to the payment transaction.

In step 302, the merchant system 112 can commission the creation of a new NFT for which an exclusive product will be available for purchase at the merchant. The merchant system 112 can commission the NFT from a creator device 118. The creator device 118 can create the NFT and register it on the blockchain associated with the blockchain network 104 using traditional methods and provide the token identifier for the commissioned NFT to the merchant system 112. In step 304, the merchant system 112 can electronically transmit a data signal to the processing server 102 using a suitable communication network and method to register the NFT and its offer of the purchase of an exclusive product as a result of ownership thereof. In step 306, the receiving device 202 of the processing server 102 can receive the data signal. The data signal can include at least the token identifier for the NFT as well as a special merchant identifier that will be used by the merchant system 112 for any payment transaction for purchase of the exclusive product. In step 308, the generation module 218 of the processing server 102 can generate a token profile 208 for the NFT that includes the token identifier and the special merchant identifier as the one or more transaction criteria, which can be stored in the token database 206 of the processing server 102 via execution of a suitable query by the querying module 216 of the processing server.

After the NFT has been registered on the blockchain and the exclusive purchase offer for the NFT registered with the processing server 102, the consumer 108 can claim ownership of the NFT, such as through purchasing the NFT from a marketplace system or another blockchain participant. The claiming of ownership by the consumer 108 can be detected by a listening system 120. In step 312, the receiving device 202 of the processing server 102 can receive an ownership transfer notification from the listening system 120 that includes the token identifier and a wallet identifier for the blockchain wallet that claimed ownership of the NFT. In step 314, the querying module 216 of the processing server 102 can execute queries on the token database 206 and account database 210 to identify the token profile 208 for the NFT whose ownership was claimed and to identify the account profile 212 that includes the wallet identifier included in the received ownership transfer notification. In step 316, the generation module 218 of the processing server 102 can generate a link between the identified token profile 208 and identified account profile 212. In some cases, the link can be created by storing the wallet identifier in the identified token profile 208 and/or storing the token identifier in the identified account profile 212.

After the consumer 108 has claimed ownership of the NFT in step 310, then, in step 318, the consumer 108 can initiate a payment transaction with the merchant system 112 for purchase of the exclusive product that is available only to owners of the commissioned NFT. As part of the initiation of the payment transaction, the consumer 108 can provide payment details for the transaction account the consumer 108 wishes to use to fund the payment transaction to the merchant system 112 using a suitable method. In step 320, the merchant system 112 can receive the payment data from the consumer 108. In step 322, the merchant system 112 can generate a transaction message for the initiated payment transaction. The transaction message can include at least the payment details and additional transaction data values, which can include any data for the payment transaction that can be used in the traditional processing of the payment transaction as well as any of the functions discussed herein. The transaction data values can include, for instance, at last the special merchant identifier used by the merchant system 112 for the payment transaction due to the payment transaction being for purchase of the exclusive product.

In step 324, the merchant system 112 can submit the transaction message for processing, such as by electronically transmitting the transaction message to their acquirer system 114. The acquirer system 114 can submit an authorization request for the payment transaction to the payment network 116 using the payment rails associated therewith, which can forward the authorization request to the processing server 102 to determine applicability of an NFT to the payment transaction and applicability of any transaction account or payment transaction blocking. In step 326, the receiving device 202 of the processing server can receive the authorization request.

In step 328, the transaction processing module 222 can, based on the transaction criteria stored in the token profile 208 (e.g., the special merchant identifier) and the transaction data values stored in the received authorization request (e.g., the same special merchant identifier), identify that ownership of the NFT associated with the identified token profile 208 is applicable to the attempted payment transaction. In step 330, the transaction processing module 222 can determine that a link exists between the token profile 208 and the account profile 212 that includes the payment account number included in the payment details included in the received authorization request. As a result of the determined link, in step 332, the processing server 102 can process the payment transaction by forwarding the authorization request to the issuer system 110, which can be identified using the payment account number. The issuer system 110 can authorize the payment transaction using traditional methods, which can result in an authorization response indicating approval of the payment transaction being returned to the acquirer system 114 and, subsequently, the merchant system 112. In step 334, the merchant system 112 can receive the authorization response, which can include a response code indicating approval of the payment transaction. In step 336, the merchant system 112 can finalize the payment transaction, such as by providing the exclusive product to the consumer 108. In step 338, the consumer 108 can receive the exclusive product from the merchant system 112. The result of the process is that the consumer 108 can receive the product by virtue of their ownership of the NFT without having to do anything beyond presenting their payment details as in a traditional payment transaction.

### Exemplary Method for Account and Transaction Blocking

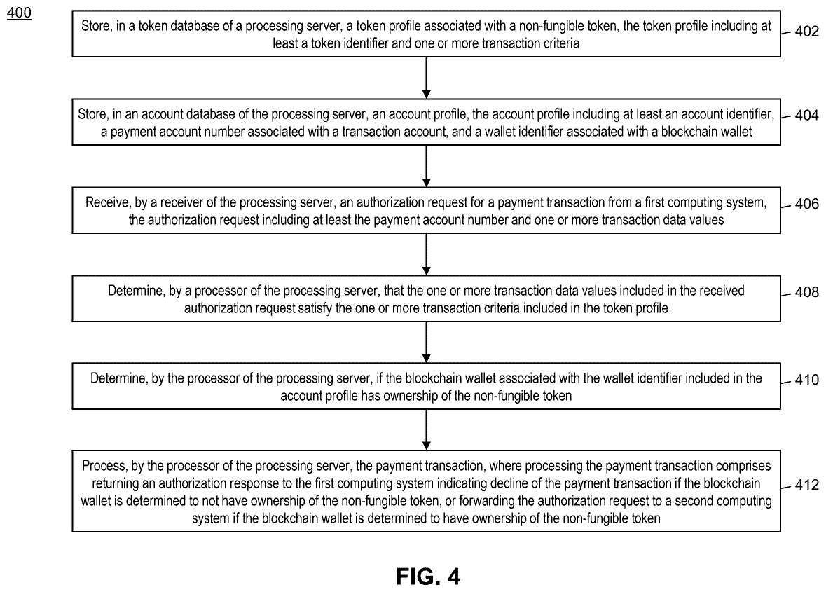

FIG. 4 illustrates a method 400 for account and transaction blocking for payment transactions using validation of non-fungible tokens (NFTs).

In step 402, a token profile (e.g., token profile 208) associated with an NFT can be stored in a token database (e.g., token database 206) of a processing server (e.g., processing server 102), the token profile including at least a token identifier and one or more transaction criteria. In step 404, an account profile (e.g., account profile 212) can be stored in an account database (e.g., account database 210) of the processing server, the account profile including at least an account identifier, a payment account number, and a wallet identifier associated with a blockchain wallet. In step 406, an authorization request for a payment transaction can be received by a receiver (e.g., receiving device 202) of the processing server from a first computing system (e.g., merchant system 112, acquirer system 114, payment network 116), the authorization request including at least the payment account number and one or more transaction data values.

In step 408, a processor (e.g., validation module 220, transaction processing module 222, etc.) of the processing server can determine that one or more transaction data values included in the received authorization request satisfy the one or more transaction criteria included in the token profile. In step 410, the processor of the processing server can determine if the blockchain wallet associated with the wallet identifier included in the account profile has ownership of the NFT. In step 412, the processor of the processing server can process the payment transaction, where processing the payment transaction comprises returning an authorization response to the first computing system indicating decline of the payment transaction if the blockchain wallet is determined to not have ownership of the non-fungible token, or forwarding the authorization request to a second computing system (e.g., issuer system 110, payment network 116, etc.) if the blockchain wallet is determined to have ownership of the non-fungible token.

In one embodiment, the token profile can further include a contract identifier corresponding to the non-fungible token on a blockchain. In some embodiments, the authorization request can be formatted according to one or more standards governing the exchange of financial transaction messages. In further embodiments, the one or more standards can include the ISO 8583 standard.

In one embodiment, the method 400 can further include: receiving, by the receiver of the processing server, an ownership transfer notification indicating transfer of ownership of the non-fungible token to the blockchain wallet, the ownership transfer notification including at least the token identifier and the wallet identifier; and storing, by the processor of the processing server, a linkage between the token profile and the account profile. In a further embodiment, determining if the blockchain wallet has ownership of the non-fungible token can include determining if the linkage between the token profile and account profile exists. In another further embodiment, storing the linkage between the token profile and the account profile can include storing the wallet identifier in the token profile. In yet another further embodiment, storing the linkage between the token profile and the account profile can include storing the token identifier in the account profile.

### Computer System Architecture

FIG. 5 illustrates a computer system 500 in which embodiments of the present disclosure, or portions thereof, can be implemented as computer-readable code. For example, the processing server 102, blockchain nodes 106, consumer 108, issuer system 110, merchant system 112, acquirer system 114, payment network 116, creator device 118, and listening system 120 can be implemented in the computer system 500 using hardware, non-transitory computer readable media having instructions stored thereon, or a combination thereof and can be implemented in one or more computer systems or other processing systems. Hardware can embody modules and components used to implement the methods of FIGS. 3A, 3B, and 4.

If programmable logic is used, such logic can execute on a commercially available processing platform configured by executable software code to become a specific purpose computer or a special purpose device (e.g., programmable logic array, application-specific integrated circuit, etc.). A person having ordinary skill in the art can appreciate that embodiments of the disclosed subject matter can be practiced with various computer system configurations, including multi-core multiprocessor systems, minicomputers, mainframe computers, computers linked or clustered with distributed functions, as well as pervasive or miniature computers that can be embedded into virtually any device. For instance, at least one processor device and a memory can be used to implement the above described embodiments.

A processor unit or device as discussed herein can be a single processor, a plurality of processors, or combinations thereof. Processor devices can have one or more processor “cores.” The terms “computer program medium,” “non-transitory computer readable medium,” and “computer usable medium” as discussed herein are used to generally refer to tangible media such as a removable storage unit 518, a removable storage unit 522, and a hard disk installed in hard disk drive 512.

Various embodiments of the present disclosure are described in terms of this example computer system 500. After reading this description, it will become apparent to a person skilled in the relevant art how to implement the present disclosure using other computer systems and/or computer architectures. Although operations can be described as a sequential process, some of the operations can in fact be performed in parallel, concurrently, and/or in a distributed environment, and with program code stored locally or remotely for access by single or multi-processor machines. In addition, in some embodiments the order of operations can be rearranged without departing from the spirit of the disclosed subject matter.

Processor device 504 can be a special purpose or a general purpose processor device specifically configured to perform the functions discussed herein. The processor device 504 can be connected to a communications infrastructure 506, such as a bus, message queue, network, multi-core message-passing scheme, etc. The network can be any network suitable for performing the functions as disclosed herein and can include a local area network (LAN), a wide area network (WAN), a wireless network (e.g., WiFi), a mobile communication network, a satellite network, the Internet, fiber optic, coaxial cable, infrared, radio frequency (RF), or any combination thereof. Other suitable network types and configurations will be apparent to persons having skill in the relevant art. The computer system 500 can also include a main memory 508 (e.g., random access memory, read-only memory, etc.), and can also include a secondary memory 510. The secondary memory 510 can include the hard disk drive 512 and a removable storage drive 514, such as a floppy disk drive, a magnetic tape drive, an optical disk drive, a flash memory, etc.

The removable storage drive 514 can read from and/or write to the removable storage unit 518 in a well-known manner. The removable storage unit 518 can include a removable storage media that can be read by and written to by the removable storage drive 514. For example, if the removable storage drive 514 is a floppy disk drive or universal serial bus port, the removable storage unit 518 can be a floppy disk or portable flash drive, respectively. In one embodiment, the removable storage unit 518 can be non-transitory computer readable recording media.

In some embodiments, the secondary memory 510 can include alternative means for allowing computer programs or other instructions to be loaded into the computer system 500, for example, the removable storage unit 522 and an interface 520. Examples of such means can include a program cartridge and cartridge interface (e.g., as found in video game systems), a removable memory chip (e.g., EEPROM, PROM, etc.) and associated socket, and other removable storage units 522 and interfaces 520 as will be apparent to persons having skill in the relevant art.

Data stored in the computer system 500 (e.g., in the main memory 508 and/or the secondary memory 510) can be stored on any type of suitable computer readable media, such as optical storage (e.g., a compact disc, digital versatile disc, Blu-ray disc, etc.) or magnetic tape storage (e.g., a hard disk drive). The data can be configured in any type of suitable database configuration, such as a relational database, a structured query language (SQL) database, a distributed database, an object database, etc. Suitable configurations and storage types will be apparent to persons having skill in the relevant art.

The computer system 500 can also include a communications interface 524. The communications interface 524 can be configured to allow software and data to be transferred between the computer system 500 and external devices. Exemplary communications interfaces 524 can include a modem, a network interface (e.g., an Ethernet card), a communications port, a PCMCIA slot and card, etc. Software and data transferred via the communications interface 524 can be in the form of signals, which can be electronic, electromagnetic, optical, or other signals as will be apparent to persons having skill in the relevant art. The signals can travel via a communications path 526, which can be configured to carry the signals and can be implemented using wire, cable, fiber optics, a phone line, a cellular phone link, a radio frequency link, etc.

The computer system 500 can further include a display interface 502. The display interface 502 can be configured to allow data to be transferred between the computer system 500 and external display 530. Exemplary display interfaces 502 can include high-definition multimedia interface (HDMI), digital visual interface (DVI), video graphics array (VGA), etc. The display 530 can be any suitable type of display for displaying data transmitted via the display interface 502 of the computer system 500, including a cathode ray tube (CRT) display, liquid crystal display (LCD), light-emitting diode (LED) display, capacitive touch display, thin-film transistor (TFT) display, etc.

Computer program medium and computer usable medium can refer to memories, such as the main memory 508 and secondary memory 510, which can be memory semiconductors (e.g., DRAMs, etc.). These computer program products can be means for providing software to the computer system 500. Computer programs (e.g., computer control logic) can be stored in the main memory 508 and/or the secondary memory 510. Computer programs can also be received via the communications interface 524. Such computer programs, when executed, can enable computer system 500 to implement the present methods as discussed herein. In particular, the computer programs, when executed, can enable processor device 504 to implement the methods illustrated by FIGS. 3A, 3B, and 4, as discussed herein. Accordingly, such computer programs can represent controllers of the computer system 500. Where the present disclosure is implemented using software, the software can be stored in a computer program product and loaded into the computer system 500 using the removable storage drive 514, interface 520, and hard disk drive 512, or communications interface 524.

The processor device 504 can comprise one or more modules or engines configured to perform the functions of the computer system 500. Each of the modules or engines can be implemented using hardware and, in some instances, can also utilize software, such as corresponding to program code and/or programs stored in the main memory 508 or secondary memory 510. In such instances, program code can be compiled by the processor device 504 (e.g., by a compiling module or engine) prior to execution by the hardware of the computer system 500. For example, the program code can be source code written in a programming language that is translated into a lower level language, such as assembly language or machine code, for execution by the processor device 504 and/or any additional hardware components of the computer system 500. The process of compiling can include the use of lexical analysis, preprocessing, parsing, semantic analysis, syntax-directed translation, code generation, code optimization, and any other techniques that can be suitable for translation of program code into a lower level language suitable for controlling the computer system 500 to perform the functions disclosed herein. It will be apparent to persons having skill in the relevant art that such processes result in the computer system 500 being a specially configured computer system 500 uniquely programmed to perform the functions discussed above.

Techniques consistent with the present disclosure provide, among other features, systems and methods for account and transaction blocking for payment transactions using validation of non-fungible tokens. While various exemplary embodiments of the disclosed system and method have been described above it should be understood that they have been presented for purposes of example only, not limitations. It is not exhaustive and does not limit the disclosure to the precise form disclosed. Modifications and variations are possible in light of the above teachings or can be acquired from practicing of the disclosure, without departing from the breadth or scope.

What is claimed is:

1. A method for account and transaction blocking for payment transactions using validation of non-fungible tokens, comprising:
storing, in a token database of a processing server, a token profile associated with a non-fungible token, the token profile including at least a token identifier and one or more transaction criteria;
storing, in an account database of the processing server, an account profile, the account profile including at least an account identifier, a payment account number associated with a transaction account, and a wallet identifier associated with a blockchain wallet;
receiving, by a receiver of the processing server, an authorization request for a payment transaction from a first computing system, the authorization request including at least the payment account number and one or more transaction data values;
determining, by a processor of the processing server, that the one or more transaction data values included in the received authorization request satisfy the one or more transaction criteria included in the token profile;
determining, by the processor of the processing server, if the blockchain wallet associated with the wallet identifier included in the account profile has ownership of the non-fungible token; and
processing, by the processor of the processing server, the payment transaction, where processing the payment transaction comprises returning an authorization response to the first computing system indicating decline of the payment transaction if the blockchain wallet is determined to not have ownership of the non-fungible token, or forwarding the authorization request to a second computing system if the blockchain wallet is determined to have ownership of the non-fungible token.

2. The method of claim 1, wherein the token profile further includes a contract identifier corresponding to the non-fungible token on a blockchain.

3. The method of claim 1, wherein the authorization request is formatted according to one or more standards governing exchange of financial transaction messages.

4. The method of claim 3, wherein the one or more standards includes ISO 8583 standard.

5. The method of claim 1, further comprising:
receiving, by the receiver of the processing server, an ownership transfer notification indicating transfer of ownership of the non-fungible token to the blockchain wallet, the ownership transfer notification including at least the token identifier and the wallet identifier; and
storing, by the processor of the processing server, a linkage between the token profile and the account profile.

6. The method of claim 5, wherein determining if the blockchain wallet has ownership of the non-fungible token comprises determining if the linkage between the token profile and account profile exists.

7. The method of claim 5, wherein storing the linkage between the token profile and the account profile includes storing the wallet identifier in the token profile.

8. The method of claim 5, wherein storing the linkage between the token profile and the account profile includes storing the token identifier in the account profile.

9. A system for account and transaction blocking for payment transactions using validation of non-fungible tokens, comprising:
a first computing system; and
a processing server, the processing server including
a token database storing a token profile associated with a non-fungible token, the token profile including at least a token identifier and one or more transaction criteria,
an account database storing an account profile, the account profile including at least an account identifier, a payment account number associated with a transaction account, and a wallet identifier associated with a blockchain wallet,
a receiver receiving an authorization request for a payment transaction from a first computing system, the authorization request including at least the payment account number and one or more transaction data values, and
a processor
determining that the one or more transaction data values included in the received authorization request satisfy the one or more transaction criteria included in the token profile,
determining if the blockchain wallet associated with the wallet identifier included in the account profile has ownership of the non-fungible token, and
processing the payment transaction, where processing the payment transaction comprises returning an authorization response to the first computing system indicating decline of the payment transaction if the blockchain wallet is determined to not have ownership of the non-fungible token, or forwarding the authorization request to a second computing system if the blockchain wallet is determined to have ownership of the non-fungible token.

10. The system of claim 9, wherein the token profile further includes a contract identifier corresponding to the non-fungible token on a blockchain.

11. The system of claim 9, wherein the authorization request is formatted according to one or more standards governing exchange of financial transaction messages.

12. The system of claim 11, wherein the one or more standards includes ISO 8583 standard.

13. The system of claim 9, wherein
the receiver of the processing server receives an ownership transfer notification indicating transfer of ownership of the non-fungible token to the blockchain wallet, the ownership transfer notification including at least the token identifier and the wallet identifier, and
the processor of the processing server stores a linkage between the token profile and the account profile.

14. The system of claim 13, wherein determining if the blockchain wallet has ownership of the non-fungible token comprises determining if the linkage between the token profile and account profile exists.

15. The system of claim 13, wherein storing the linkage between the token profile and the account profile includes storing the wallet identifier in the token profile.

16. The system of claim 13, wherein storing the linkage between the token profile and the account profile includes storing the token identifier in the account profile.
